(19) United States
(12) Patent Application Publication
(10) Pub. No.: US 2011/0215564 A1
(43) Pub. Date: Sep. 8, 2011

(54) Three Bolt Breakaway Coupling

(76) Inventor: Andrew Charles Abrams, Bryn Mawr, PA (US)

(21) Appl. No.: 12/716,343

(22) Filed: Mar. 3, 2010

(51) Int. Cl. F16L 17/00; F16B 31/00; F16L 35/00

(52) U.S. Cl. 285/95; 411/43; 285/304

(57) ABSTRACT

There is disclosed a three bolt breakaway coupling adapted to be connected to either one or both ends of a flexible fluid conduit having a housing at each end that may include a valve. The breakaway coupling has two generally triangular shaped flanges where each flange has a central opening surrounded by a sealing member such as an 0 ring and an opening located at each corner of each triangular shaped flange for receiving a shear bolt. At least two of the three shear bolts which couple the two triangular flanges together will break when a specified pull at any angle is applied to the three bolt breakaway coupling. The first and second housings may contain valves for controlling the flow of a fluid through the conduit.

### BACKGROUND OF THE INVENTION

1. Field of the invention

The present invention relates generally to a breakaway coupling for connection to an flexible fluid conduit used for transferring gas or liquid under a high pressure. More particularly, this invention relates to a breakaway coupling having three shear bolts that hold two substantially triangular flanges together to provide a leak proof connection there between and is adapted to be located between flexible fluid conduit and a housing for a valve where at least two of the three shear bolts of the breakaway coupling separate at the same time during the occurrence of a specific pull force at any angle.

2. Description of Related Art

When filling containers with compressed or non-compressed gasses or liquids, or operating equipment that relies on pressurized liquid flow or compressed gas, it is necessary for the liquid or gas, hereinafter referred to a fluid, to be transferred from one container to another. Although the fluid can be transferred from one container to another using solid piping, it is common in many situations to use a flexible conduit or hose between the containers. A flexible hose allows ease of connection/disconnection of containers, as well as a limited range of motion between the source and destination.

For example, compressed or non-compressed fluids, such as oxygen, nitrogen, carbon dioxide, chemicals, petroleum, petroleum products and acids are transported, stored and used in containers of varying size. To fill these containers with the desired product, it is necessary to connect each container to a filling connection at the location of a gas filler/seller. In order to connect each container to the filling connection, a flexible hose is used which allows for quick connection/disconnection of the container to the filling connection. A filling station manifold is one example of a filling connection.

The flexible hose used to transfer the fluid, which is usually made of durable and flexible materials can fail. A common type of hose failure can occur when the hose is stretched and develops a failure because the coupling does not break away when an operator of a tank truck drives away while the flexible hose which is attached to the tank truck is still attached to the existing tank,

The prior art coupling in se today consists of two rectangular plates where each plate has a central opening connected to a conduit with a leak proof seal and four shear bolts. When assembled, the two rectangular plates are positioned against each other with four clearance openings for the four shear bolts and the central openings aligned with each other. A leak proof seal such as an O ring is located in an annular groove around the central opening and four shear bolts are placed into each of the four clearance openings. A nut is placed on each bolt and each nut is tightened until each bolt is stressed to the same predetermined force.

A drive away hose failure can be a rupturing of the hose caused by a partial separation of the coupling where, because of the angle of the pull not all of the shear bolts break and the plates are held together by the shear bolt(s) that did not break.

When a hose fails, it can result in personal injury as well as property damage. Still further, a hose failure can result in a leak from both the delivery and receiving ends of the flexible fluid conduit resulting in a discharge of a hazardous fluid, as well as filling the environment with hazardous fumes.

U.S. Pat. No. 5,357,998 discloses a fluid conduit safety system that uses a relatively stiff flexible cable inside a hose to maintain single valve bodies at each end of the hose in an open position during normal or open operation. When a failure condition, such as a rupture, cut, separation or stretch of the hose occurs, the valve bodies are able to seat with the valve seats, sealing both ends of the hose. This prevents fluid leaks from both sources, i.e., container and filling apparatus. When a failure of the hose does occur, the stiff flexible cable may be severed, allowing the fluid pressure to force the valve bodies into engagement with the valve seats. If a hose failure does not sever the cable, the valve seats are either forced into engagement with the valve bodies or the valve bodies are forced into engagement with the valve seats. In either circumstance, a seal is accomplished by seating the valve bodies with the valve seats. U.S. Pat. Nos. 6,260,569 and 6,546,947 disclose additional improvements in such a safety fluid conduit system. These patents disclose a system that operates when there is a drive away hose failure where the hose ruptures or there is a full separation of the plates of a four shear bolt breakaway coupling. However, the above fluid conduit systems may not immediately operate to stop the flow of fluid through the hose when used with a traditional four bolt breakaway coupling where a partial coupling separation such as where less than all of the shear bolts do not break at the same time and the plates of the four bolt breakaway coupling remain held together by one or more shear bolt(s) that did not break.

What is needed is a new improved breakaway coupling that can be used with a flexible fluid conduit where all the shear bolts separate at the same time to provide a complete and full separation of the coupling when the breakaway coupling is subjected to a designated pull force that is applied at any angle. The disclosed breakaway coupling increases the safety of the flexible hose and facility by providing protection against the unintended pull away of tank trucks, railcars, barges and ships.

### SUMMARY OF THE INVENTION

There is disclosed a three bolt breakaway coupling that can be coupled to either one or both ends of a flexible fluid conduit. The breakaway coupling of this invention is readily applied to a new flexible fluid conduit or to retrofitting an existing flexible fluid conduit. The breakaway coupling has two generally triangular shaped flanges of a metal such as stainless steel, steel, iron, bronze, brass or the like, where each flange has a central opening surrounded by a sealing member such as a sealing O ring. Located at each corner of the two generally triangular shaped flanges is an opening for receiving a shear bolt. The breakaway coupling here disclosed has only three shear bolts.

To assemble, an O ring is placed in a groove in one of the triangular flanges that encircles the central opening, and the two triangular flanges are positioned opposite each other with the openings at the corners of the two triangular flanges aligned with each other. Shear bolts are then inserted into the aligned three openings, nuts are threaded onto the ends of the three shear bolts and each nut is tightened to apply the same foot/lbs torque to each shear bolt.

The three bolt breakaway coupling here disclosed can be located at either one or both ends of a flexible fluid conduit.

In a flexible fluid conduit, also referred to herein as a hose, first and second housings which can contain valves are attached to first and second ends of the flexible fluid conduit and the breakaway coupling is located between at least one end of the flexible hose and a housing.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings wherein similar reference numeral represent similar parts throughout the various views of the drawings.

FIG. 1 is a cut away view of a flexible hose conduit coupled to a three bolt breakaway coupling located between the flexible hose conduit and a housing in accordance with the principles of the invention;

FIG. 2 is a cut away view of a fluid conduit safety system showing a drive away failure where the three bolt breakaway coupling has separated to prevent a hose rupture in accordance with the principles of the invention;

FIG. 3 is a diagram of a fluid/gas transport vehicle delivering or receiving fluid/gas to or from a source/destination through flexible fluid conduit having a three bolt breakaway coupling in accordance with the principles of the invention;

FIG. 4 is a side view of a three bolt triangular flange breakaway coupler located between a housing and a tubular member adapted to be connected to a flexible fluid conduit in accordance with the principles of the invention;

FIG. 5 is a view along the line 5-5 of FIG. 4 looking at the interior side of a three bolt triangular flange breakaway coupler n accordance with the principles of the invention;

FIG. 6 is a bottom view of the three bolt triangular flange breakaway coupler of FIG. 4 in accordance with the principles of the invention; and

FIG. 7 is an isometric view of a three bolt triangular flange breakaway coupler of FIG. 4 in accordance with the principles of the invention.

### DESCRIPTION OF THE PREFERRED EMBODIMENT

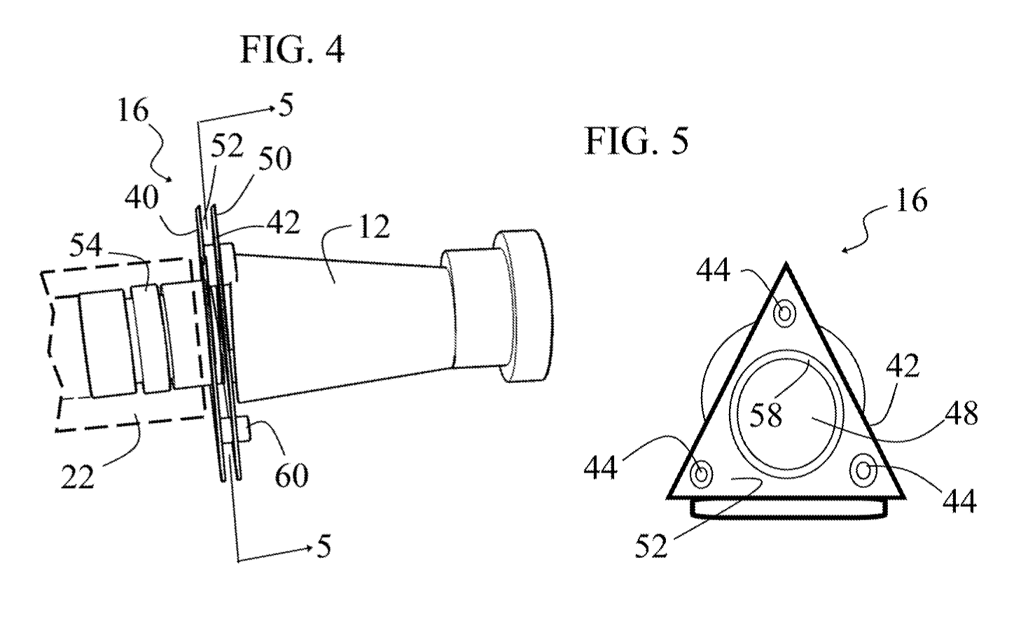

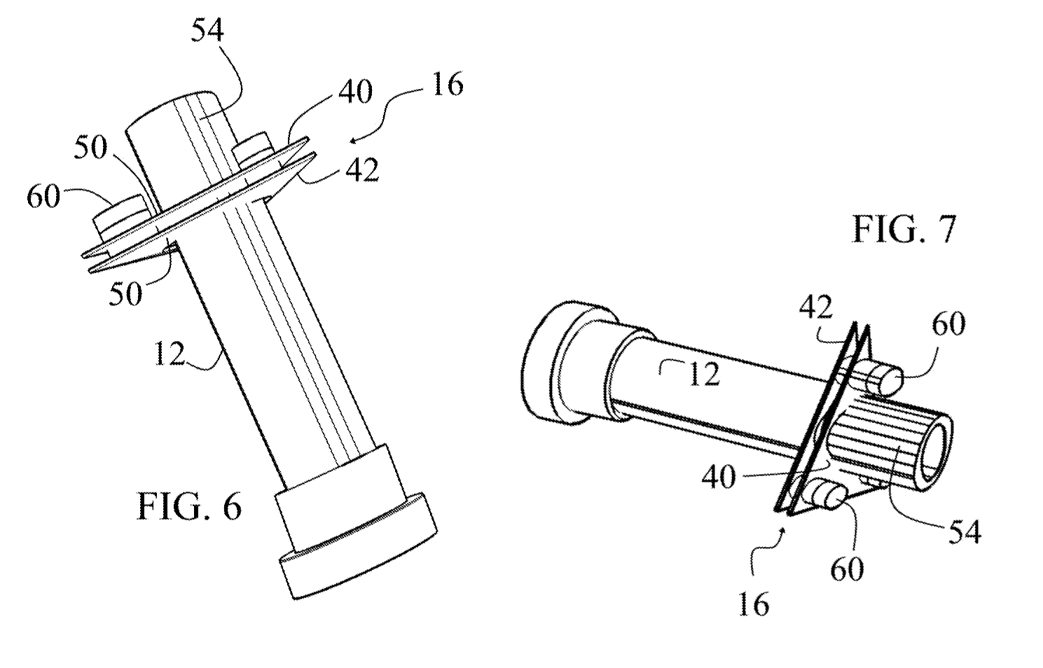

There is disclosed a three bolt breakaway coupling that can be used in combination with a flexible fluid conduit such as a flexible hose with housing body that can include a valve for sealing both ends of the hose when a hose failure occurs. As shown in FIGS. 4-7 and more fully referred to below, a three bolt breakaway coupling for use with a flexible fluid conduit is disclosed. The breakaway coupling consists of two substantially similar triangular flanges composed of steel, iron, bronze or any other suitable material. Each triangular shape flange has three openings, an opening at each corner, for receiving three breakaway bolts. The openings can have a circular shape, or they can have a U shape or a modified shaped opening such as an L shape opening.

In an embodiment, the openings in each of the two flanges can be clearance openings for receiving a threaded shear bolt.

In another embodiment, the openings in one of the flanges can be clearance openings for a threaded shear bolt and the openings hi the mating flange can be threaded for receiving threads of the shear bolts.

In another embodiment the openings in one of the flanges can be clearance openings for receiving a threaded shear bolt and the openings in the mating flange can have shear bolts that are press fit into the openings. The flanges are held together with nuts that are threaded onto the ends of the shear bolts.

In another embodiment the shear bolts can be provide in various sizes and materials to meet specific pressure and/or load requirements.

In each of the above embodiments the shear bolts separate at the same time when subjected to a designated pull force from any angle.

Each flange has a centrally located opening that provides a path for a fluid such as a gas or a liquid to pass through. The openings at the three corners of the two triangular shaped flanges for the shear bolts are positioned uniformly around the central opening and are separated from each other by 120 degrees.

Each flange has an exterior side and an interior side where the interior side of the flanges face each other when the breakaway coupling is assembled. The exterior side of one flange is adapted to be connected to a longitudinally extending tubular member aligned with the centrally located opening and supports on its outer surface a plurality of ridges which are provided for clamping a flexible fluid conduit to the tubular member in a leak proof manner. The exterior side of the other flange is adapted to be connected to a housing which includes at its end coupling means such as threads or the like for connection to a container or a tank truck for receiving/dispensing a fluid that can be under pressure.

The two mating triangular flanges of the disclosed three shear bolt breakaway coupling device here disclosed fully separates when subjected to a designated breaking force applied at any angle because each of the three shear bolts break at the same time.

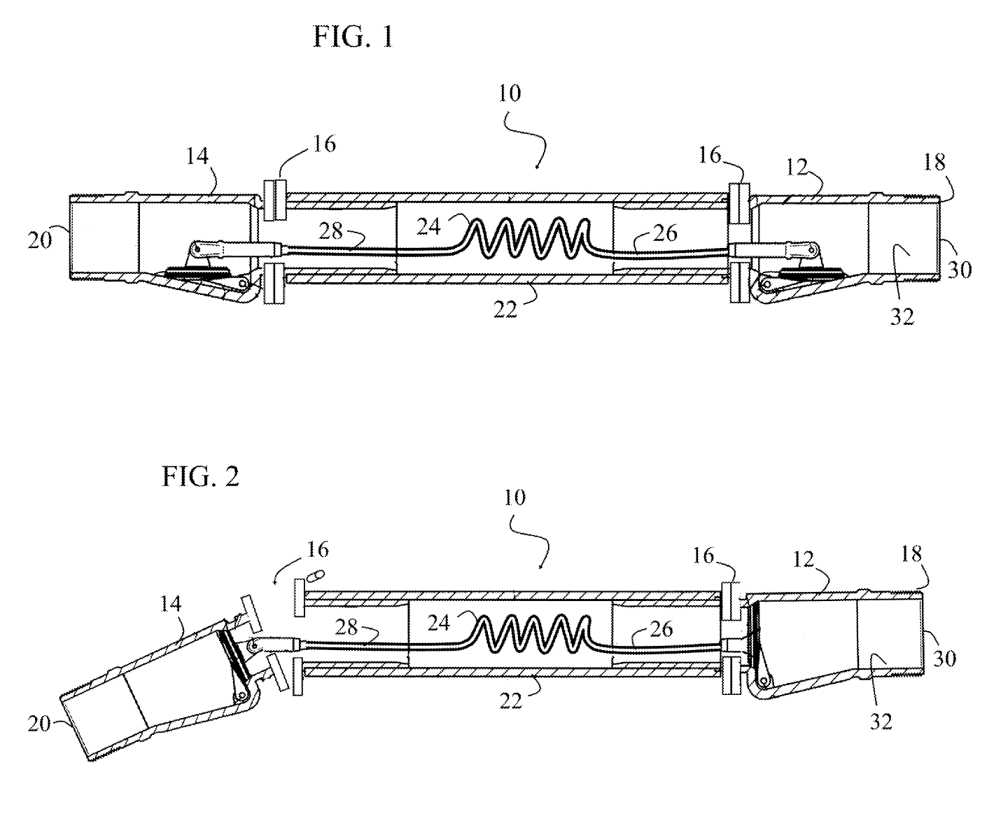

Referring to FIG. 1, there is shown a flexible fluid conduit assemblage 10 having a housing 12, 14 at each end, each of which is coupled to the three bolt breakaway coupling 16 located between the housings and an end of the flexible fluid conduit 22.

Connector ends 18, 20 are identical in design, except that they are positioned at opposite ends of hose the assemblage. Accordingly, fluids will flow from one connector end to the other, depending upon whether a container is being filled or being emptied.

Connector end 18 includes housing 12 which can include a valve such as a flapper valve and means for connecting the end 18 of the housing to a container, manifold or other connection to receive or discharge a fluid. In an exemplary embodiment, housing 12 is connected to a three bolt breakaway coupler 16 having triangular flanges and is made of a metal such as brass, iron, steel or the like. Other materials can be used that can withstand the pressure and chemical environment of the fluid that is being carried through the flexible conduit. Housing 12 is substantially hollow, having a center cavity 32 through which fluids may pass between housings 12 and 14.

In an exemplary embodiment, housings 12 and 14 are made of a metal such as brass or steel, or a plastic or composite material. Other materials can be used that can withstand the pressure and chemical environment. A spring 24 in compression is located in conduit 22 which applies thrust through relatively stiff bendable spring rods 26, 28 to urge flapper type valves at each end of the conduit to stay open to allow full fluid flow. Upon the occurrence of a conduit failure the increase in the length of the conduit is greater than the increase in the length of the spring which converts the push on the valves to a pull on the valves and the flapper type valves are pulled closed to prevent fluid flow through the conduit. The compression spring can work where the hose elongates since the spring coil can be designed to address this elongation. The spring coil can be made so that when it expands from its compressed state to its naturally coned uncompressed position it can expand by an amount equal to the hoses elongation thereby permitting elongation.

Referring to FIG. 2, there is shown a cut away view of the fluid conduit safety system of FIG. 1 showing a drive away failure where all three bolts of the breakaway coupler 16 have separated to prevent a hose failure.

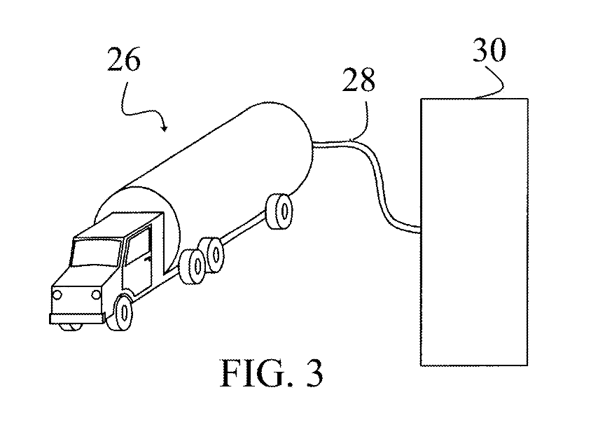

Referring to FIG. 3, there is shown a diagram of a fluid/gas transport vehicle. 26 delivering or receiving fluid/gas to or from a source/destination through flexible fluid conduit assemblage 28 having a three bolt breakaway coupling connected to a sour &destination container 30. Transport vehicle 26 can be delivering or receiving a fluid, depending upon the particular application.

In operation, a first end of the flexible fluid conduit is connected to a filling container, while the second end of the fluid conduit is connected to a receiving container. The exact nature of the filling container and the receiving container depends upon the ultimate application. For example, the filling container may be a transport vehicle connected through a hose or a routing system before a connection is made to the flexible fluid conduit of the present invention. A similar situation may apply to the receiving container. In addition, the receiving container may be the actual use of the fluid which is thus not actually contained.

Referring to FIGS. 4, 5, 6, and 7, there is shown a three bolt breakaway coupling 16 for use with a flexible fluid conduit. The three bolt breakaway coupler 16 consists of a first flange 40 and a second flange 42 each of which can have a shape that is preferably triangular, but can be circular, oblong, etc. and can be composed of steel, iron, brass, bronze, and the like. In the embodiment shown in FIGS. 4-7 each flange has a triangular shape and each flange has three openings 44, see FIG. 5, for receiving breakaway bolts 60. In an embodiment, the openings in the first flange can be clearance openings for a threaded shear bolt and the openings in the second flange can be threaded for receiving the threads of shear bolts. Each flange has a centrally located opening 48 that provides a path for a fluid such as a gas or a liquid to pass through. The openings in the triangular flanges for the shear bolts are positioned uniformly around the central opening 48 and are separated from each other by 120 degrees.

Each flange has an exterior side 50 and an interior side 52 where the interior sides of the flanges face each other when the three bolt breakaway coupling is assembled. The exterior side of flange 40 is connected to a longitudinally extending tubular member 54 that is aligned with the centrally located opening 48 and supports on its outer surface a plurality of ridges 56 which are provided for holding flexible fluid conduit 22 in a leak proof manner when clamped with clamps.

The interior side of each flange supports a groove 58 located around the centrally located opening for receiving an O ring. When the two flanges are bolted together, the O ring provides a leak proof seal.

In another embodiment a leak proof seal can be obtained with a metal-to-metal seal and one end of each threaded shear bolts is press fit into an opening in one of the flanges.

The exterior side of the second flange 42 is attached to housing 12, see FIG. 1.

To assemble the three bolt breakaway coupling, an O ring is positioned in groove 58 in one of the flanges and the interior sides of the two flanges are positioned opposite each other with the openings 44 of the two flanges in alignment. The threaded ends of breakaway bolts (shear bolts) 60 are then inserted into clearance openings in the first flange and threaded into the threaded openings in the second flange. The breakaway bolts can have hexagonal heads and can be made of stainless steel or other metal such as steel, iron and the like. A predetermined torque in foot-lbs. is applied to each of the three shear bolts.

All three shear bolts of the three bolt breakaway coupling break at the same time when the three bolt coupler is subjected to specified pulling force from any direction. Thus, two or more of the shear bolts will break at any time when a breaking force is applied at any angle to the three bolt breakaway coupling here disclosed.

Shear bolts that are of various sizes and/or material can be used to meet specific pressure and load requirements. Because at least two or more of the shear bolts will break at the same time, increased safety and protection is provided against an unintended pull away of tank trucks, railcars, barges and ships.

The three bolt breakaway coupling can be used at either one or both ends of a flexible fluid conduit.

The ends 18, 20 of the housings can have external or internal coupling threads, however other connection means can be provided such as a bayonet type closure.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is

1. A breakaway coupling for use with a flexible fluid conduit comprising:
a longitudinally extending tubular member coupled to an end of the flexible fluid conduit;
a generally triangular shaped first flange having an exterior side, an interior side and a centrally located fluid passageway, said exterior side coupled to an end of said tubular member;
an opening located at each of the three corners of said triangular shaped first flange;
a generally triangular shaped second flange having an exterior side, an interior side and a centrally located fluid passageway, said exterior side coupled to a housing that may include a valve;
an opening located at each of the three corners of said triangular shaped second flange;
wherein said interior sides of said first and second flanges are positioned opposite each other and said openings at the corners are aligned;
a threaded shear bolt located in each of the three aligned openings in the first and second flanges for coupling said first and second flanges together and forming a leak proof connection between the two flanges;
wherein at least two of said shear bolts break and said first flange is separated from said second flange when said breakaway coupling is subjected to a predetermined pull from any angle.

2. The breakaway coupling of claim 1 wherein said openings in said first flange are clearance openings for a shear bolt; and said openings in said second flange are clearance openings for a shear bolt.

3. The breakaway coupling of claim 1 wherein said openings in said first flange are threaded for receiving a threaded shear bolt; and said openings in said second flange are clearance openings for receiving the threaded shear bolt for said first flange.

4. The breakaway coupling of claim 1 wherein said openings in said first flange are clearance openings for receiving threaded shear bolts; and said openings in said second flange have shear bolt that are press fit into said openings.

5. The breakaway coupling of claim 1 wherein said openings in said first and second flanges are circular openings.

6. The breakaway coupling of claim 1 wherein said openings in said first and second flanges are U shaped notches.

7. The breakaway coupling of claim 1 wherein said openings in one of said flanges are U shaped.

8. The breakaway coupling of claim 1 wherein said openings in at least one of said flanges are L shape.

9. The breakaway coupling of claim 1 wherein said threaded shear bolts are sized to meet a specific pull requirement.

10. The breakaway coupling of claim 9 wherein said threaded shear bolts are sized to meet a specific pressure requirement.

11. The breakaway coupling of claim 1 wherein said threaded shear bolts are made of stainless steel.

12. The breakaway coupling of claim 1 further comprising a second housing coupled to a second end of said flexible fluid conduit wherein said first and second housings each have a valve.

13. The breakaway coupling of claim 12 wherein said valves in said first and second housings are operatively coupled to a prior art control structure that closes each of the valves when the breakaway coupling separates.

14. The breakaway coupling of claim 1 wherein a leak proof O ring seal is located between said first and second flanges.

15. The breakaway coupling of claim 1 wherein a leak proof metal-to-metal seal is located between said first and second flanges.
